(19) United States
(12) Patent Application Publication
(10) Pub. No.: US 2007/0183640 A1
(43) Pub. Date: Aug. 9, 2007

(54) Gated cone-beam computed tomography reconstruction with motion compensation

(75) Inventors: Robert Manzke, Husberg (DE); Thomas Koehler, Norderstedt (DE); Michael Grass, Buchholz in der Nordheide (DE); Babak Movassaghi, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 10/599,140

(22) PCT Filed: Mar. 18, 2005
(86) PCT No.: PCT/IB05/50940

§ 371 Date: Sep. 21, 2006

(30) Foreign Application Priority Data
Mar. 25, 2004 (EP) 04101250.1

(51) Int. Cl. G06K 9/00

(52) U.S. Cl. 382/131

(57) ABSTRACT

E.g. in cardiac cone-beam CT, the source path is interrupted due to the fact that the projection data is gated. According to the present invention, a method is provided to obtain projection data corresponding to an uninterrupted source trajectory from such a gated data set. For this purpose, a motion compensation is applied. Advantageously, a complete data set may be determined allowing for an approximate or an exact reconstruction method to be applied to the completed data set without interruption of the image generation.

The present invention relates to the field of computed tomography such as cone-beam CT. In particular, the present invention relates to a method of reconstructing projection data from a gated projection data set, to an image processing device, to a computed tomography apparatus and to a computer program for reconstructing projection data from a gated projection data set.

Cone-beam computed tomography (CBCT) enables volumetric imaging at high spatial resolution. With the improved acquisition speed, cardiac CT imaging has become feasible. However, due to the gating of the projection data, the source orbit is interrupted, resulting in a reduced dose efficiency and prohibiting the use of exact reconstruction techniques as, for example, described in B. D. Smith “Image reconstruction from cone-beam projections: necessary and sufficient conditions and reconstruction methods” IEEE trans. med. image., MI-4:14-25, 1985.

In such cardiac cone-beam computed tomography systems, the source path i.e. the path of the source during which data is gathered is interrupted due to the fact that the projection data is gated. In cardiac cone-beam computed tomography, the gating may be performed in accordance with an electro-cardiogram (ECG) or any other suitable means for detecting the movement of the heart. Due to the gating, a majority of projection data is discarded which strongly decreases the dose utilization. Furthermore, in some cases, the 3D completeness criterion for exact reconstruction as formulated by Tuy may be violated resulting in incomplete radon data and thus prohibiting the use of exact reconstruction techniques.

It is an object of the present invention to provide for an improved reconstruction.

According to an exemplary embodiment of the present invention as set forth in claim 1, the above object may be solved by a method of reconstructing projection data from a gated projection data set wherein the gated projection data set is firstly acquired. The source trajectory, i.e. the trajectory of the source of radiation used for acquiring the gated projection data set, has at least one gap due to gating. In case the method is applied to a CBCT, the gating is preferably performed in accordance with a movement of the heart which, as described above, may be determined by means of an electrocardiogram or other suitable means. Then, new projection data is determined corresponding to the at least one gap and the gated projection data is supplemented with the new projection data to compensate for the at least one gap in the source trajectory.

Advantageously, the supplemented gated projection data may thus be completed in a way that, for example, the three-dimensional completeness criterion for exact reconstruction is no longer violated resulting in complete radon data. This advantageously may then allow the use of exact reconstruction techniques.

According to another exemplary embodiment of the present invention as set forth in claim 2, a four-dimensional image data set is reconstructed from the gated projection data by using a cone-beam computed tomography reconstruction. On the basis of this four-dimensional image data set as set forth in the exemplary embodiment of claim 3, a four-dimensional vector field may be determined which describes the motion of the object of interest which is imaged. This motion field may then be used for performing a motion compensation of the gated projection data.

In other words, an approximate reconstruction technique may be used to reconstruct a four-dimensional data set. From this four-dimensional data set, a four-dimensional vector field is calculated. Then, the four-dimensional image data is motion compensated.

According to another exemplary embodiment of the present invention as set forth in claim 4, the four-dimensional image data is motion compensated and then, the motion compensated four-dimensional data is used to calculate new projection data for completing the original data set, i.e. for filling the gap. Advantageously, this may allow to form a complete gated projection data set without gaps which may allow for the application of exact or quasi-exact reconstruction techniques.

Then, as set forth in the exemplary embodiment of the present invention as defined in claim 5, an approximate or an exact reconstruction algorithm or method may then be applied to the gated projection data which was supplemented with the new projection data which allows to reconstruct the final image data without interruption for the image generation.

Advantageously, this may allow for an improved image quality and for a fast and robust reconstruction.

According to another exemplary embodiment of the present invention as set forth in claim 6, an image processing device is provided comprising a processor for reconstruction projection data from a gated projection data set. Advantageously, the image processing device is adapted to perform an operation to supplement the gated projection data such that gaps in the data caused by an incomplete source trajectory are filled.

Advantageously, this image processing device allows for a very exact and fast reconstruction. Another exemplary embodiment of the image processing device is set forth in claim 7.

According to another exemplary embodiment of the present invention as set forth in claim 8, a computed tomography apparatus is provided comprising a processor which is adapted to perform an operation in accordance with the method of the present invention. Advantageously, this computer tomography apparatus allows for an exact or quasi-exact reconstruction of data in spite of an interrupted source trajectory due to a gating.

According to another exemplary embodiment of the present invention as set forth in claim 9, a computer program for a data processor for reconstructing projection data from a gated projection data set is provided. The computer program according to the present invention is preferably loaded into a working memory of a data processor. The processor is thus equipped to carry out an exemplary embodiment of a method of the present invention. The computer program may be stored on a computer readable medium, such as a CD-ROM. The computer program may also be presented over a network such as the WorldWideWeb, and can be downloaded into the working memory of a data processor from such a network. The computer program may be written in any suitable programming language, such as C++.

It may be seen as a gist for an exemplary embodiment of the present invention that projection data may be obtained corresponding to an uninterrupted source trajectory from a gated data set where the source path was interrupted due to the fact that the data acquisition was gated. For this purpose, a motion compensation is applied. An approximate reconstruction is used to reconstruct a four-dimensional data set. From this data set, a four-dimensional vector field is calculated. The four-dimensional image data is then motion compensated and subsequently used to calculate new projection data completing the data set. The new projection data corresponds to the missing data, i.e. to the gaps in the interrupted source path. Then, an appropriate or even exact reconstruction algorithm may be applied to the data set without interruption for the image generation.

These and other aspects of the present invention will become apparent from and will be elucidated with reference to the embodiments described hereinafter.

Exemplary embodiments of the present invention will be described in the following with reference to the following drawings:

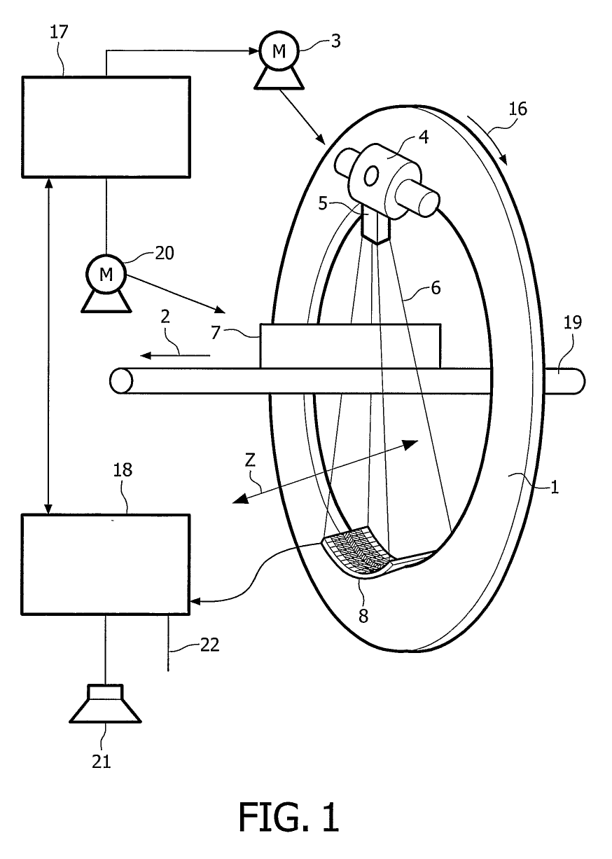

FIG. 1 shows a schematic representation of an exemplary embodiment of a cone-beam computed tomography scanner as it may be used for cardiac cone-beam CT according to the present invention.

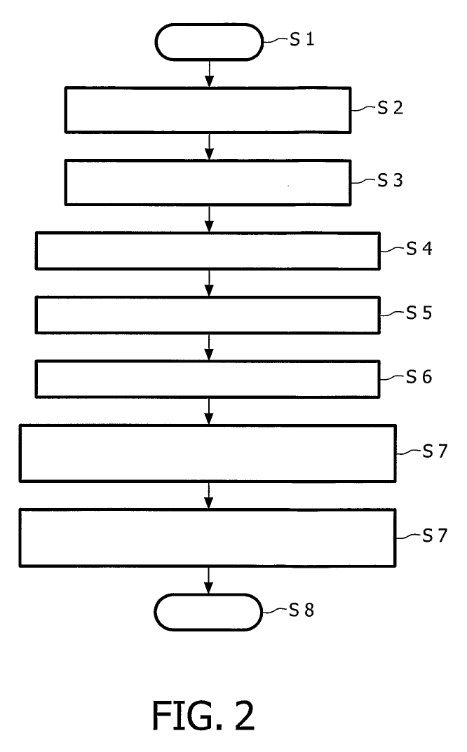

FIG. 2 shows an exemplary embodiment of a method of operating the computed tomography apparatus of FIG. 1.

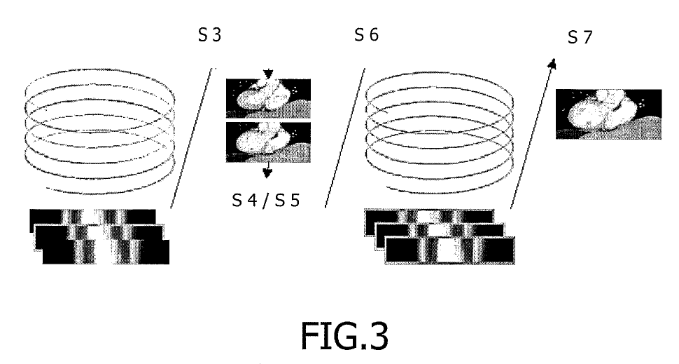

FIG. 3 shows a schematic representation for further explaining a principle of an exemplary embodiment of the present invention.

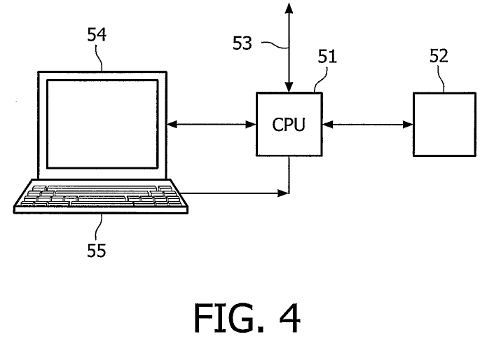

FIG. 4 shows a simplified schematic representation of an exemplary embodiment of a data processing device according to the present invention.

FIG. 1 shows an exemplary embodiment of a computed tomography apparatus according to the present invention. Preferably, this is a cone-beam computed tomography apparatus (CBCT) where a cone-beam 6 is applied to an object of interest. With reference to this exemplary embodiment, the present invention will be described for the application in cardiac cone-beam CT. However, it should be noted that the present invention is not limited to a cardiac CT, but may be applied to any CT imaging method where an incomplete data set is used due to a gating or a suitable sampling. In other words, the present invention may be applied to the imaging of moving objects in general where certain movement stages are imaged.

The CBCT scanner depicted in FIG. 1 comprises a gantry 1 which is rotatable around a rotational axis 2. The gantry 1 is driven by means of a motor 3. Reference character 4 designates a source of radiation, such as an x-ray source which according to an aspect of the present invention emits a polychromatic radiation.

Reference character 5 designates a first aperture system which forms the radiation emitted from the radiation source 4 to a cone-shaped radiation beam 6.

The cone-shaped radiation beam 6 (or cone-beam) is directed such that it penetrates the object of interest 7 arranged in the centre of the gantry, i.e. in an examination region of the CBCT scanner, and impinges onto the detector 8. As may be taken from FIG. 1, the detector 8 is arranged on the gantry 1 opposite to the source of radiation 4. The detector 8 depicted in FIG. 1 has a plurality of detector lines each comprising a plurality of detector elements.

The detector lines of the detector 8 are arranged at the gantry 1 such that the lines are perpendicular to the rotational axis 2. Furthermore, columns of the detector 8 are essentially parallel to the rotational axis 2. In other words, the detector 8 may be a two-dimensional detector.

The apertures of the aperture system 5 is adapted to the dimensions of the detector 8 such that the scanned area of the item of interest 7 is within the cone-beam 6 and that the detector 8 covers the complete scanning area. Advantageously, this allows to avoid unnecessary excess radiation applied to the object of interest 7. During a scan of the object of interest 7, the source of radiation 4, the aperture system 5 and the detector 8 are rotated along the gantry 1 in the direction indicated with arrow 16. For rotation of the gantry 1 with the source of radiation, the aperture system 5 and the detector 15, the motor 3 is connected to a motor control unit 17 which is connected to a calculation unit 18.

In FIG. 1, the object of interest 7 is disposed on a rest 19, which may be movable. According to an exemplary embodiment of the present invention, as mentioned above, a circular data acquisition is performed where the x-ray source 4 is displaced along a circular source trajectory i.e. is rotated in a rotational plane around the rotational axis 2 without a movement of the object of interest in a direction parallel to the rotational axis 2. Thus, the object of interest may be immobile when the x-ray source 4 performs a circular movement. However, according to another exemplary embodiment of the present invention, for achieving a helical source trajectory, the object of interest 7 may be moved on or together with the rest 19 in a direction parallel to the rotational axis 2.

The detector 8 is connected to a calculation unit 18. The calculation unit 18 receives the detection results i.e. read-outs from the detector elements of the detector 8 and determines a scanning result on the basis of the scanning results from the detector 8. In addition to that, the calculation unit 18 communicates with the motor control unit 17 in order to coordinate the movement of the gantry 1 with the motor 3 and 20 or with the rest 19. The calculation unit 18 is adapted for reconstructing an image from read-outs of the detector 8. The image generated by the calculation unit 18 may be output to a display (not shown in FIG. 1) via an interface 22.

FIG. 2 shows an exemplary embodiment of a method of operating the computed tomography apparatus of FIG. 1.

After the start in step S1, the method continues to step S2 where a data acquisition is performed. In particular, in step S2 projection data of a three-dimensional volume is acquired. Due to a gating process performed, the three-dimensional volume that is acquired has gaps. For example, for a cardiac cone-beam CT, the source path is interrupted due to the fact that the projection data is gated according to an electrocardiogram (ECG) or to any other suitable means adapted to determine a movement of the heart. Due to this, a part of the projection data that is actually acquired is discarded which strongly decreases the dose utilization. This causes the gaps in the source trajectory i.e. the gap in the three-dimensional image volume that is acquired. Furthermore, due to this, a 3D completeness criterion for extract reconstruction may be violated which results in an incomplete radon data set.

Then, in the subsequent step S3, a four-dimensional image data set is reconstructed. For the case of a cardiac CBCT reconstruction, a four-dimensional image data set may be reconstructed by means of an approximate reconstruction algorithm such as, for example, described in Grass, M. et. al. “Helical cardiac cone-beam reconstruction using retrospective ECG gating” Phys. Med. Biol. 2003, which is hereby incorporated by reference or Kachelrieβ, M. et. al. “ECG-correlated image reconstruction from subsecond multi-slice spiral CT scans of the heart” Med. Phys., 27(8): 1881-1902, 2000, which is also hereby incorporated by reference.

Then, in a subsequent step S4, a vector field is calculated. In particular, from the four-dimensional image data reconstructed in step S3, a four-dimensional vector field is calculated using, for example, a three-dimensional registration technique or block matching algorithm, such as described in Schäffter T. et. al. “Motion compensated projection reconstruction” 41: 954-963, 1999, which is hereby incorporated by reference.

Then, in subsequent step S5, the four-dimensional vector field determined in step S4 is used for a motion compensation of the three-dimensional volume acquired in step S2. Then, in the subsequent step S6, the motion compensated image data is used to fill gaps in the trajectory by calculating new projection data with e.g. forward projection.

Then, in subsequent step S7, an approximate or an exact reconstruction algorithm, such as described, for example, in Katsevich, A. “Analysis of an exact inversion algorithm for spiral cone-beam CT” Phys. Med. Biol., 47: 2583-2597, 2002, and Katsevich, A. “Theoretically exact FBP-type inversion algorithm for spiral CT” SIAM J. App. Math., 62: 2012-2026, 2002, which are both hereby incorporated by reference, may be applied. Such reconstruction algorithm may be used to reconstruct the final volume (images) using the motion compensated projection data. Advantageously, this may allow for an improved dose efficiency and thereby a decrease of a dose of radiation applied to, for example, a patient.

Advantageously, the above method may furthermore allow for the application of large area detectors for which an exact or quasi-exact reconstruction approach, such as the one described above, is necessary.

FIG. 3 shows a simplified schematic representation for visualizing the method described with reference to FIG. 2. As may be taken from FIG. 3, due to the gating, the source trajectory from which the data is acquired which is used for subsequent reconstruction is interrupted. In the case of cardiac CT, the source trajectory is interrupted due to ECG-gating. According to the present invention, in the subsequent step S3, an approximate three-dimensional reconstruction is performed for different phases. Then, the method continues to steps S4 and S5 where a four-dimensional vector field determined from four-dimensional image data is used for motion compensation of the image data. Then, the motion compensated data is used to fill the gaps in the trajectory by calculating new projection data with forward projection. Then, the motion compensated and supplemented image data is used for an approximate or an exact reconstruction algorithm which allows, for example, for an exact three-dimensional reconstruction from the completed data set.

FIG. 4 shows an exemplary embodiment of a data processing device, such as an image processing device, for performing the method described with reference to FIGS. 2 and 3. As may be taken from FIG. 4, a central processing unit (CPU) or image processor 51 is connected to a memory 52 for storing a gated projection data set, any intermediate data or the finally reconstructed data. The data may be acquired by a CBCT scanner such as the one depicted in FIG. 1. For this, the image processor 51 may be connected to such a CBCT scanner and/or to a plurality of input/output/network or other diagnosis devices. The processor 1 is furthermore connected to a display 54 (for example to a computer monitor) for displaying information or images computed or adapted in the image processor 1. An operator may interact with the data processor 51 via a keyboard 55 and/or other input or output devices which are not depicted in FIG. 1.

The present invention described above may, for example, be applied in the field of medical imaging. However, as described above, the present invention may also applied in other areas where moving objects are to be examined, such as in the field of non-destructive testing.

1. Method of reconstructing projection data from a gated projection data set, the method comprising the steps of: acquiring the gated projection data set; wherein source trajectory used for acquiring the gated projection data set has at least one gap due to gating; determining new projection data corresponding to the at least one gap; and supplementing the gated projection data with the new projection data to compensate for the at least one gap in the source trajectory.

2. The method of claim 1, further comprising the step of: reconstruction a four-dimensional image data set from the gated projection data by using a cone beam computed tomography reconstruction (CBCT) method.

3. The method of claim 2, further comprising the steps of: determining a four-dimensional vector field from the four-dimensional image data set; wherein the four-dimensional vector field describes a motion of an object of interest; and performing a motion compensation of the gated projection data set by using the four-dimensional vector field.

4. The method of claim 3, further comprising the step of; determining the new projection data on the basis of the motion compensated three dimensional image volume.

5. The method of claim 1, further comprising the step of: reconstructing the projection from the gated projection data supplemented with the new projection data; wherein the gated projection data set is a three-dimensional data set.

6. Image processing device, comprising: a memory for storing a gated projection data set; and a processor for reconstructing projection data from a gated projection data set, wherein the processor is adapted to perform the following operation: acquiring the gated projection data set from the memory; wherein source trajectory used for acquiring the gated projection data set has at least one gap due to gating; determining new projection data corresponding to the at least one gap; and supplementing the gated projection data with the new projection data to compensate for the at least one gap in the source trajectory.

7. The image processing device of claim 6, wherein the processor is further adapted to perform the following operation: reconstruction a four-dimensional image data set from the gated projection data by using a cone beam computed tomography reconstruction (CBCT) method; determining a four-dimensional vector field from the four-dimensional image data set; wherein the four-dimensional vector field describes a motion of an object of interest; performing a motion compensation of the gated projection data set by using the four-dimensional vector field; and determining the new projection data on the basis of the motion compensated three dimensional image volume; wherein the gated projection data set is a three-dimensional data set.

8. Computed tomography apparatus, comprising: a memory for storing a gated projection data set; and a processor for reconstructing projection data from a gated projection data set, wherein the processor is adapted to perform the following operation: acquiring the gated projection data set from the memory; wherein source trajectory used for acquiring the gated projection data set has at least one gap due to gating; determining new projection data corresponding to the at least one gap; and supplementing the gated projection data with the new projection data to compensate for the at least one gap in the source trajectory.

9. A computer program for reconstructing projection data from a gated projection data set, wherein the computer program causes a computer to perform the following operation when the computer program is executed on the computer: acquiring the gated projection data set; wherein source trajectory used for acquiring the gated projection data set has at least one gap due to gating; determining new projection data corresponding to the at least one gap; and supplementing the gated projection data with the new projection data to compensate for the at least one gap in the source trajectory.
